(19) United States
(12) Patent Application Publication
(10) Pub. No.: US 2008/0087141 A1
(43) Pub. Date: Apr. 17, 2008

(54) Adjustable, torque compensating powered pipe wrench

(76) Inventor: Herman Myburgh, Lascassas, TN (US)

Correspondence Address: LITMAN LAW OFFICES, LTD., P.O. BOX 15035, CRYSTAL CITY STATION, ARLINGTON, VA, 22215, US

(21) Appl. No.: 11/907,516

(22) Filed: Oct. 12, 2007

Related U.S. Application Data
(60) Provisional application No. 60/851,281, filed on Oct. 13, 2006.

(51) Int. Cl. B25B 17/00

(52) U.S. Cl. 81/57.15

(57) ABSTRACT

Adjustable, torque compensating powered pipe wrench for the tightening and loosening of threaded pipe onto threaded pipe fittings. A portable wrench with size adjustable non-rotating grippers and size adjustable rotating grippers powered by a drive motor allows for the powered tightening and loosening of threaded pipe onto threaded pipe fittings.

### CROSS-REFERENCE TO RELATED APPLICATIONS

This application claims the benefit of U.S. Provisional Patent Application Ser. No. 60/851,281, filed Oct. 13, 2006.

### BACKGROUND OF THE INVENTION

1. Field of the Invention

The present invention relates to tools used in the plumbing trade, and particularly to an adjustable, torque compensating powered pipe wrench for use with threaded pipe and threaded pipe fittings.

2. Description of the Related Art

The current practice of threading-in, unthreading, tightening, and loosening of threaded pipe to threaded pipe fittings is a manual process whereby normally two pipe wrenches are employed. One pipe wrench is adjusted and attached to grab onto the threaded pipe fitting in manner to allow desired rotational direction grabbing of the pipe fitting. The second pipe wrench is adjusted and attached to grab onto the threaded pipe in a manner and allow the desired opposite rotational directional grabbing of the pipe to allow for the desired threading or un-threading of the pipe from the pipe fitting. This process is normally performed by a person manually pulling the handles of the pipe wrenches together to compensate for torque or when a solid object is available in the close proximity to the work being performed one pipe wrench would be supported against the solid object while the second pipe wrench handle will be pulled or pushed towards the first pipe wrench to perform the desired threading or un-threading of the pipe in relation to the pipe fitting. To properly perform this function requires the exertion of significant human physical force and is very prone to the injuring of the person performing this function as well as any helpers or bystanders, more so, since this process is very often performed while the person is standing on a ladder, scaffold or lift and the function is periodically overhead. This function is also performed while standing on the ground employing clamping tables or threading machines to clamp or hold either the pipe or the pipe fitting and the mating pipe or fitting is grabbed with a pipe wrench. While working on the ground using clamping tables or the like, does marginally reduce the physical exertion as well as the risk of personal injury. The majority of the plumbing work involving the threading and un-threading of pipes and pipe fittings has to be done overhead while working in the air on a platform and the like. The practice of using pipe wrenches for the threading, un-threading, tightening and loosening of threaded pipe and threaded pipe fittings exist from the inception of threaded pipe and threaded pipe fittings with virtually no change to pipe wrench design other than introduction of self adjusting pipe wrenches. Despite the substantial awareness of as well as increased legislation in the area of worker safety, no powered tool has yet been developed for this unsafe, physically straining everyday process. Numerous electric, pneumatic and hydraulic powered hand tools are currently available for practically every traditionally manual operation including nut setters, air wrenches electric screwdrivers, electric drills, impact wrenches, riveters, threading tools, etc. All these power tools significantly improve worker safety, productivity and mobility in addition to drastically reducing worker fatigue.

Thus, an adjustable, torque compensating powered pipe wrench solving the aforementioned problems is desired.

### SUMMARY OF THE INVENTION

It is a principal object of the invention to provide an adjustable torque compensating powered wrench for the threading in, unthreading, tightening and loosening of threaded pipe onto threaded pipe fittings. The portable wrench having openable jaws consisting of size adjustable, non-rotating torque compensating gripper teeth. The openable jaws also contain size adjustable rotating gripper teeth alongside the non-rotating gripping teeth powered for rotation by a drive motor driven through a reduction gearbox. The powered wrench also incorporates a handle and handholding areas with hand switches for torque adjustment and power on, power off and speed control of the wrench.

These and other features of the present invention will become readily apparent upon further review of the following specification and drawings.

### BRIEF DESCRIPTION OF THE DRAWINGS

FIG. 1 is a side view of a powered torque compensating pipe wrench according to the present invention.

FIG. 2 is a top view of a powered torque compensating pipe wrench according to the present invention.

FIG. 3 is a perspective view of the opened jaws of a powered, torque compensating pipe wrench according to the present invention.

FIG. 4 is a perspective view of the jaws end of a powered, torque compensating pipe wrench clamped onto a threaded pipe and threaded pipe fitting.

Similar reference characters denote corresponding features consistently throughout the attached drawings.

### DETAILED DESCRIPTION OF THE PREFERRED EMBODIMENTS

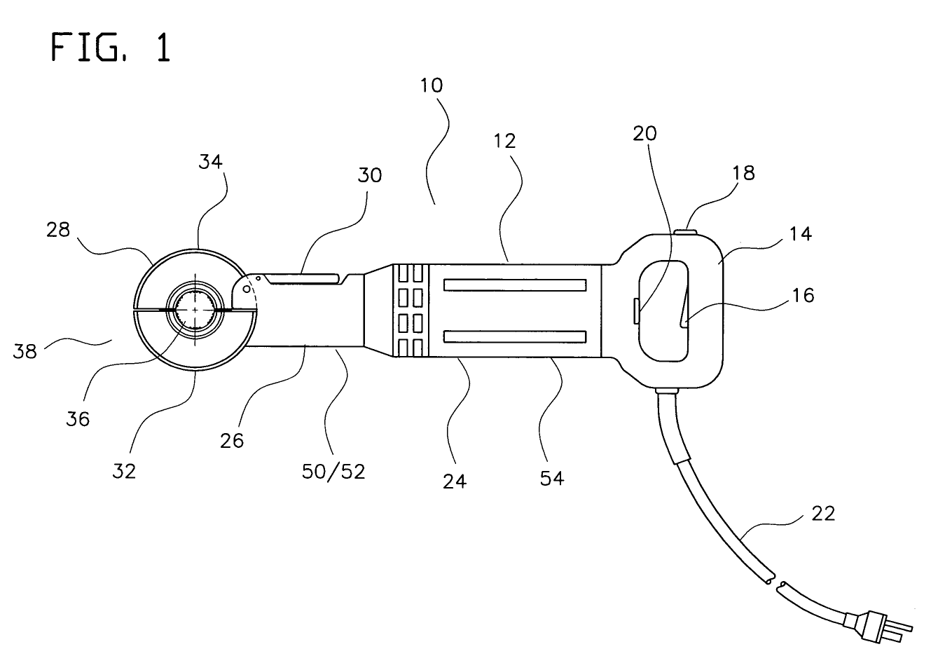

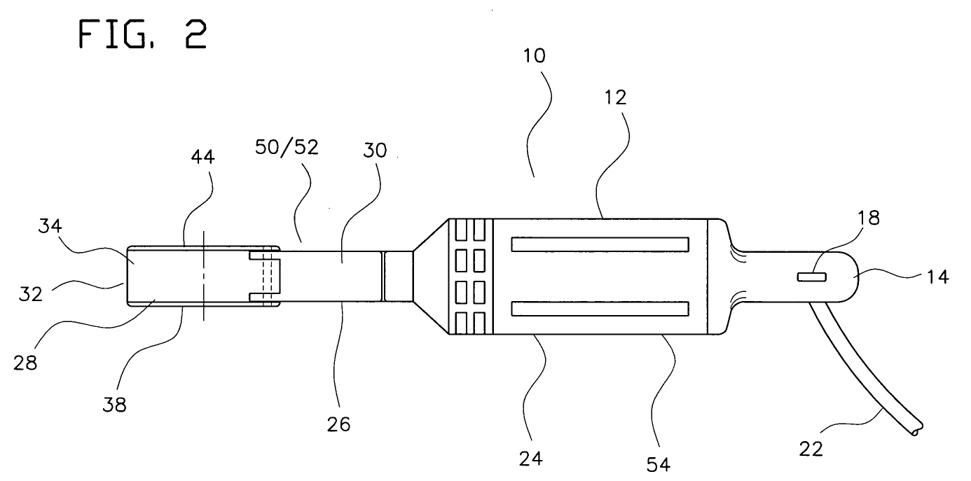

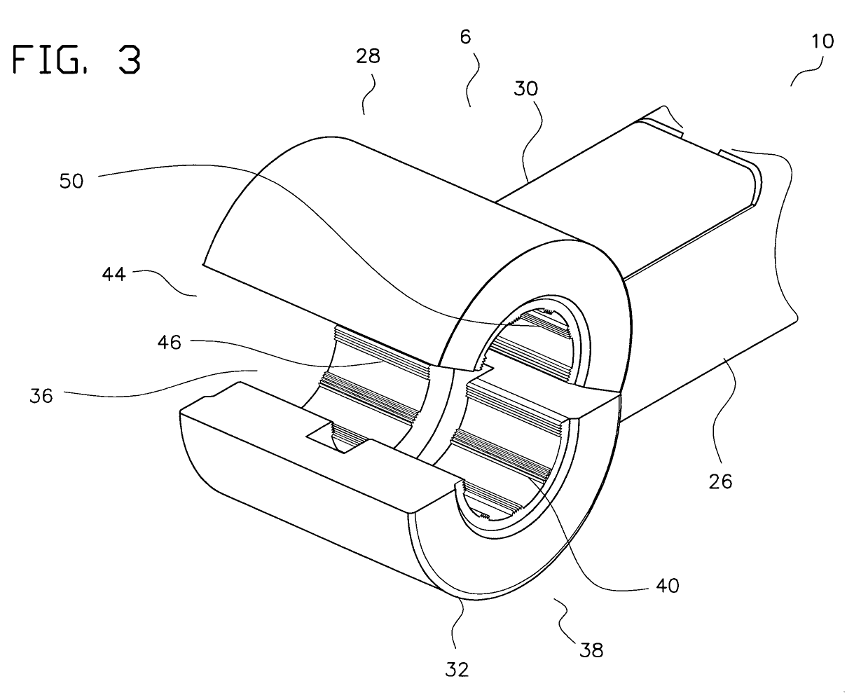

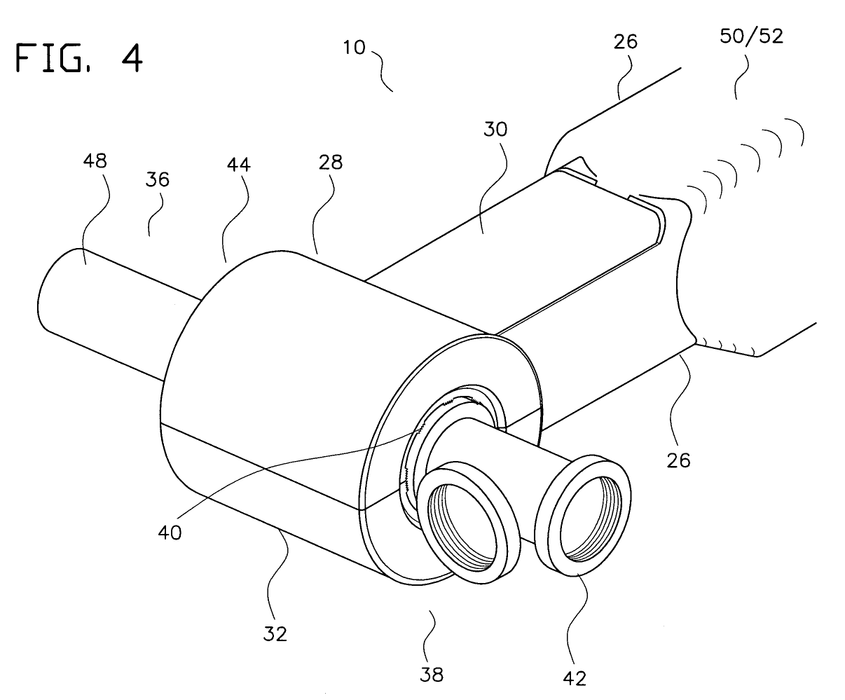

In FIG. 1 and FIG. 2 a side view and top view respectively is shown of a powered, torque compensating pipe wrench 10 according to the present invention. Pipe wrench having a main body 12, an operator's handle 14 incorporating an activating lever 16, on/off switch 18, torque setting knob 20 and a power input 22. An electric cord power input is shown but it should be understood and be obvious that the invention could also be battery, pneumatic or hydraulic powered. The powered, torque compensating pipe wrench 10 in FIG. 1 and FIG. 2 also shows the pipe wrench 10 as having integral to the main body 12 a motor housing 24, a gearbox housing 26 and a clamping head 28 as well as a locking lever 30. The clamping head 28 in FIG. 1 and FIG. 2 as well as enlarged views FIG. 3 and FIG. 4 consists of a stationary portion 32 as well as a hingeable portion 34. When clamped together clamping head 28 of pipe wrench 10 a cylindrical through cavity 36 is created as shown in FIG. 1, FIG. 3 and FIG. 4 internally on one side 38 of the clamping head 28 non-rotating clamping jaws 40 spaced along the internal perimeter of the thorough cavity 36 and adjusted to provide a stationary non-rotating clamping as shown in FIG. 3 and FIG. 4 onto in this illustration a threaded pipe fitting 42. Internally on the opposite side 44 of clamping head 28, rotating clamping jaws 46 spaced along the internal perimeter of the through cavity 36 and adjusted to clamp onto in this illustration a threaded pipe 48. Rotating clamping jaws 46 when clamped onto threaded pipe 48 are powered for circular rotation for threading of pipe into or out of threaded pipe fitting 42 by reduction gearing 50 through gearbox 52 powered by drive motor 54. Threading in, threading out, or tightening and loosening of threaded pipe and, pipe fittings is accomplished by selecting direction of rotation with the in/off/out switch as indicated in FIG. 1 and FIG. 2. FIG. 4 shows a threaded pipe fitting 42 clamped on the non-rotating clamping jaw 40 side 38 of the invention holding the pipe fitting 42 from rotating while rotating or threading the threaded pipe 48 on the opposite side 44 by means of the rotating clamping jaws 46. This operation can be reversed with the threaded pipe 48 being held from rotating and rotating the threaded pipe fitting 42 by turning the powered, torque compensating pipe wrench 10 over and clamping the threaded pipe 48 on side 38 and clamping the threaded pipe fitting 42 on side 44. This reversing procedure is common practice in plumbing skill. Preferred embodiments have been shown only and it is to be understood that the present invention is not limited only to the embodiments above.

It is to be understood that the present invention is not limited to the embodiments described above, but encompasses any and all embodiments within the scope of the following claims.

I claim:

1. An adjustable, torque compensating powered pipe wrench, comprising:
a housing defining a handle;
a motor disposed in the housing;
a pair of clamping jaws extending from the housing, the jaws being elongated laterally and having a non-rotating gripping end and a rotatable gripping end opposite the non-rotating gripping end, opposite ends of the clamping jaws being adapted for gripping threaded pipe and threaded pipe fittings;
a gear train coupling the motor to the rotatable gripping end of the clamping jaws; and
a switch electrically connected to the motor, the switch being movable between a first position in which the rotatable gripping end remains stationary and a second position in which the motor drives the rotatable gripping end to rotate.
